(19) United States
(12) Patent Application Publication
(10) Pub. No.: US 2004/0264126 A1
(43) Pub. Date: Dec. 30, 2004

(54) Universal laptop case

(76) Inventor: Eric Wells, Memphis, TN (US)

Correspondence Address: Eric Wells, 611 Jennette Place, Memphis, TN, 38126, US

(21) Appl. No.: 10/603,246

(22) Filed: Jun. 26, 2003

(51) Int. Cl. G06F 1/20

(52) U.S. Cl. 361/687

(57) ABSTRACT

The physical, expandable, customizing, configuring component chassis for laptops, tablets, notebooks, and hybrid notebooks transforms literally. The case is in three main parts: the top, upper lid, the middle, inner cover, and bottom housing. This removable upper lid houses the display screen on the inside and the solar cells on the back of the lid. The next section is the slim, narrow, middle, inner unit which holds the speakers, mouse pads, keyboards, LDC readout, small display screen, motherboards, expansion cards, and controller cards. It is detachable from the top or bottom section of the case forming a diversified case. The bottom of the case has the physical, drawer like, expandable, slidable ends to the right and left of the front of the case and knockout panels, which are for mounting the face of the peripherals. A part of the bottom will be the unique sliding ends, snap-in components mounting to the removable mounting board. The mounting board will be screwed in to be secure. The middle and bottom sections can be separated into a two piece case. This case will be composed of a top lid and either/or middle or bottom section, forming a complete computer housing.

### CROSS-REFERENCE TO RELATED APPLICATIONS

This application claims the benefit of Provisional Patent Application Ser. No. 60/390,888. Date 2002 Jun. 25.

### BACKGROUND

1. Field of the Invention

The invention is an expandable universal fitting enclosure for peripherals of standardized computers and laptop components.

2. Description of Prior Art

One of the last shortcomings of the first portable computer cases since the late 70's is the lack of interchangeable parts. Originally, the shortcoming of portable computer cases were weight, power, and non-interchangeable parts.

Thereafter, inventors created several types of enclosure chassis units for flexibility and changeable modules to accomodate packaging. U.S. Pat. No. 6,206,480 B1 to Thompson discloses a dual or single case mobility, computing and communication system with rapid mobility for usage in the field, consisting of a component mounting mechanism, a mobile computer and peripheral data switching micro-network, an enclosed modular peripheral power system, and a plug-in modular component card system. This system is not versatile enough and is limited with regard to size for expansion.

U.S. Pat. No. 5,552,957 to Brown is primarily a dual case solution with an option for a single cause configuration. He has an invention to provide a packaging structure for a portable computing system. However, this system is not user friendly.

U.S. Pat. No. 4,216,522 to Slagel has an apparatus, permitting a user of an apparatus to plug a selected integrated circuit, mounted in a standard dual-inline package, into a socket in some apparatus or by permitting the end user to plug an interchangeable printed socket in the apparatus. This is a clear-cut way to insert a circuit into an electronic device, but does not allow for modern computer peripherals.

U.S. Pat. No. 3,925,710 to Ebert invention relates to electronic equipment packaging, and more particularly, to a standard, general purpose package that offers a wide degree of flexibility in interfacing a variety of existing and/or new electronic equipment without requiring a redesign of the package for each different application. This invention to be versatile for electronics, but not laptop computers.

U.S. Pat. No. 5,936,380 to Parrish, an invention that relates generally to the use of power from solar cells in a connection with laptop, portable, and/or notebook computers. More particularly, the present invention relates to the manner in which solar cells can be used effectively in the electrical power system of such a computer. This design is effective in recapturing wasted light, but offers little in capturing light around the outside of the case.

Des. 430118 to Huriki et al. The portable computer is hearty designed, but has limited expansion. This unit is limited to overall size and expansion.

### SUMMARY

The objective of this invention is to provide an expandable, standardized, do-it-yourself, user-friendly computer case for laptops, notebooks, and tablets for multiple computer units in one case. It is also an objective of the present invention to provide such a device that is of simple, inexpensive construction. Another objective is to provide such a device in lightweight form that can be assembled and dis-assembled quickly, and is easy to transport.

A further object is to provide a universal fitting, physically expandable case that can hold one or more motherboards with knockout panels and supporting peripherals. The two units can operate separately or in a network with two to four multi-tasking systems on the two or more units.

Another principal object is the power feather prolonging the operational life of a battery power. Solar cells are incorporated onto the back of the computer case's display screen of a notebook/laptop computer to provide power to components and charging powering and/or regulation of a battery used for a power source.

### OBJECTS AND ADVANTAGES

Universal Laptop Case, unlike many, can be used with most computer's present designs, but is a proprietary computer case only for its system. The Universal Laptop Case will fit all systems and create new markets to use as multiple-based computers, instruments, test analysis systems and equipment. This system provides:

(a) a color enclosure that will be changeable.

(b) an enclosure for a rapid change and mounting different components.

(c) an enclosure which is both flexible and physically changeable.

(d) an enclosure with several motherboards simultaneously and operating systems.

(e) power and power saving features, using solar panels and battery regeneration.

(f) three (3) main detachable units, which can be reconfigured into a tablet or notebook.

(g) a multi-tasking main frame network device, a multi-integrated system, utilizing virtual equipment based computers, and dedicated controller board applications.

Further objects and advantages are to provide a closure, which can be used easily and conveniently. The bottom will have a handle to carry the entire case and the main overall horizontal parts.

The three parts are the Top (outer section), Middle (center inner section), and the Body (outer section). The body shape can vary, but it will be mostly common rectangular shaped. There will be an elbow-joint to keep the top from opening too wide.

The top is a slim, narrow, lid on the upper half of the case or body. On the back and outer part of the lid is a solar cell panel. And, on the inner-part of the lid is the display screen with a camera, microphone, LDC, and light indicator. This lid is attached to a removable hinge that allows straight or bent configuration for a tablet or notebook. The lid contains a special plug that fits into a socket of the body of the case. These hinges are mounted to the lower back. Also, the case will have knockout panels on the outside of the base for expansion component placement.

The next section is the middle, which also has removable hings on the backside. This section houses possibly, a rectangular section for mouse pads, speakers, light indicators, keyboards, LDC screen, and the remote radio section. This section, also, will have batteries for remote access power. There will, also, be a controller circuit in this section.

The last part is the bottom section, which, also, has removable hinges. It is the part that houses the motherboards, and peripherals. This section has expandable sections, which are on the long ends of this possible rectangular base, are detachable, sliding, heads, which physically expand the case for additional space. Each can slide seven inches to increase the case. The sliding part will have walls on the bottom and top that fits inside the main rectangle. There will be metal levers shaped like an “L” that will fit into a hole to stop parts from moving between where the two parts meet. There will be a wall with holes to run connections together. The top part will have a cover that covers the peripherals when separated. This cover can be moved back and forth by sliding it into grooves for access. In the very bottom of this section is the mounting board. The case will have knockout panels on the outside of the base for expansion component placement. On the inside of the main case, there will be a board in the bottom that will be fastened down by screws. This board is where the electronics and card will be connected. There are many holes to position it any place. These connections will use a push down button fastener and will release the components. Some cards will plug into the inner side of the bottom case.

The physical, expandable laptops literally transform into a hybrid customizing case. The case is in three main parts: the top, upper lid, the middle, inner cover, and bottom housing. The removable upper lid houses the display screen on the inside and the solar cells on the back of the lid, next section is the slim, narrow, middle, inner cover that holds the speakers, mouse pads, keyboards, LDC readout, and small display screen, and also, it is detachable from the top or bottom, forming a configuring case. The bottom of the case has the physical, drawer-like, expandable, slideable ends to the right and left of the front of the case and knockout panels, which will be for mounting the face of the peripherals. A unique part of the bottom will be the movable, sliding rails, snap-in components mounting to the removable mounting board, which will be screwed in to be secured.

Reference Numerals In Drawings

1 Handle

2 Mice

3 Speakers

4 Right Keyboard

5 Left Keyboard

6 Knockout Panels

7 Right Display Screen

8 Left Light Indicators

9 Left Display Screen

10 Right Light Indicator

11 Plug-In Play Slots (right)

12 Plug-In Play Slots (left)

13 Plug-In Play Slots (left, right, & rear)

14 Plug-In Play Slots (rear)

15 Mounting Board

16 Lifting Lid

17 Top Lid (side view)

18 Back Housing to Display Screen

19 Metal Frame

20 Mounting Plate & Screws for Rubber Restrainer

21 Front Cover for Rubber Display

22 Perforated Section for Front Rubber Cover Display

23 Holding Screws

24 Bracket Mount

25 Vertical Arm for Mount

26 Holding Screws

27 Horizontal Tract

28 Bracket Mount

29 Holding Screw

30 Area to Housing Display Screen

31 Sliding Mounting Unit (Rear Cover)

32 Perforated Section for Sliding Mounting Unit

33. Outer Facing Cover for Sliding Mounting Unit

34. Outside Housing of the Bubbled Edge of Rear Display Unit.

35. Solar Panel (Center & Rear View)

36. Inner Bubbled Edge

37. Lighting Indicators

38. Power Light Indicator

39. Right Side of Display Screen

40. Left Side of Display Screen

41. Retractable Feet

42. Hinges

43. Mounted Motherboards

44. MCICIA Card Slot

45. Left Expansion Drawer

46. Right Expansion Drawer

47. Retracting Handle (Side View)

48. Retracting Handle (Top View)

49. Retracting Handle (Alternate View)

50. Access Flap

51. Ventilation Holes

52. Bottom Mounting Screws

53. Back View of Middle Section

54. Antenna

55. Plug-In Connection & Flap

56. Ventilation Fan

57. Back Section of Case

58. Mounting Board

59. Mounting Screw

60. Mounting Holes on Board

61. Close-Up View of Mounting Holes on Board

62. Close-Up View of Mounting Holes

63. Locking Apparatus for Expandable Drawer

64. Plug-In Play Slots

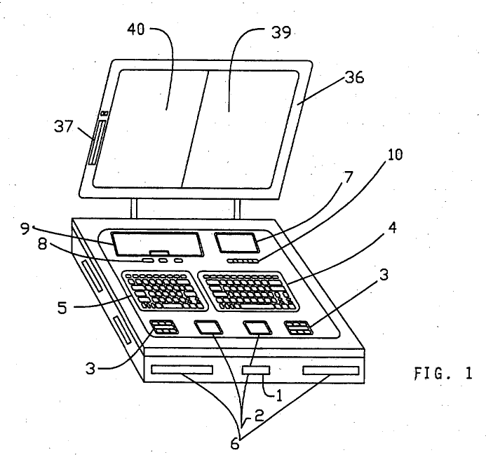

### DESCRIPTION-FIGS. 1-64-PREFERRED EMBODIMENT

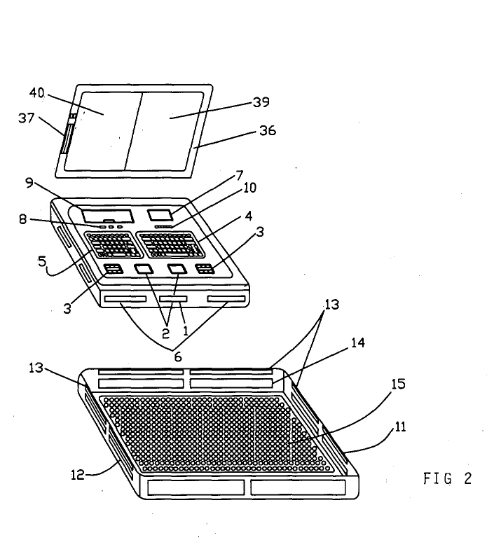

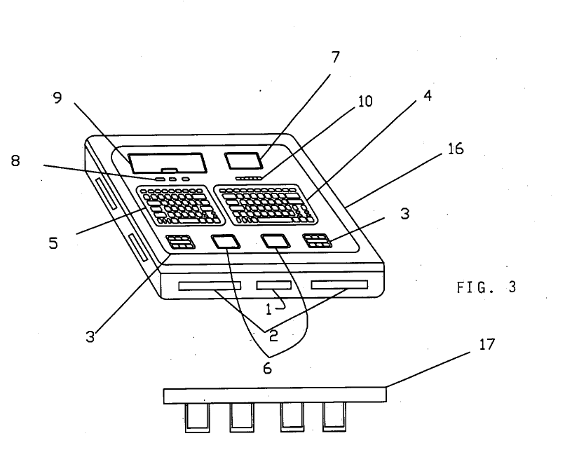

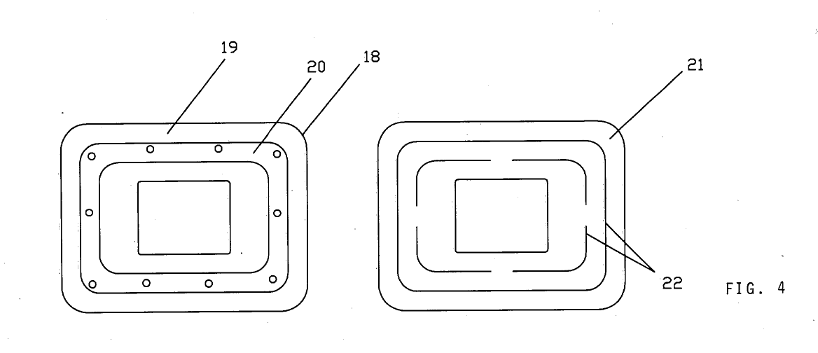

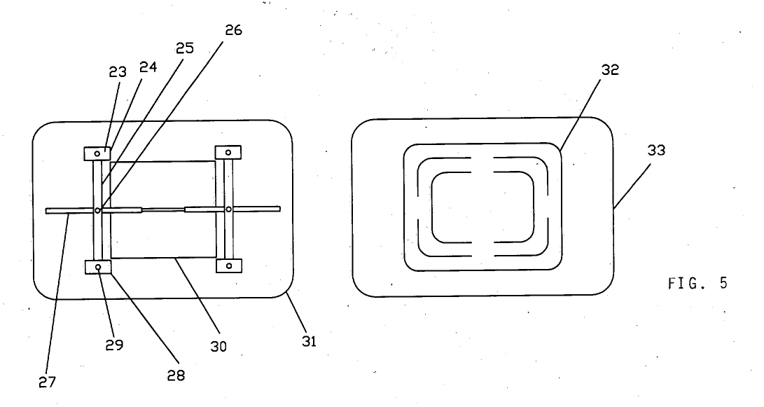

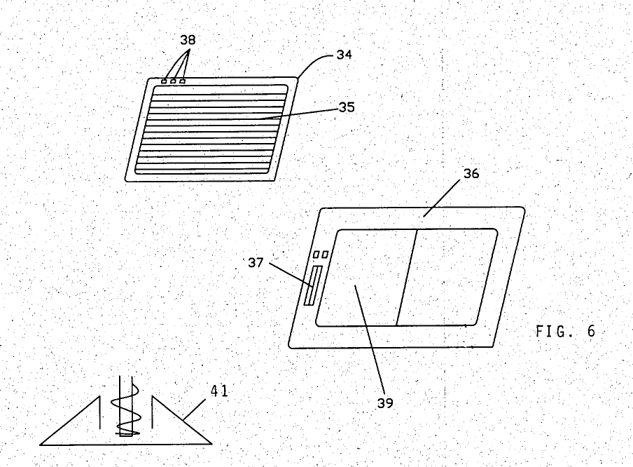

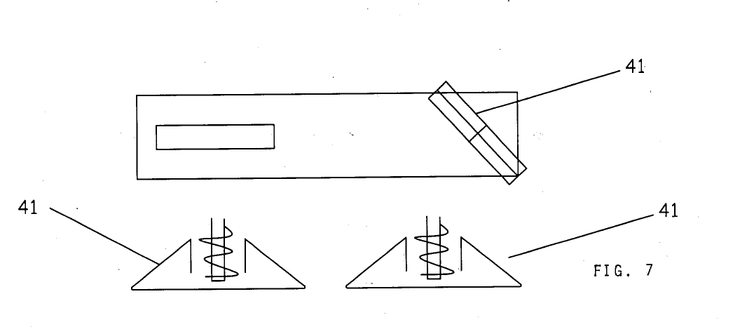

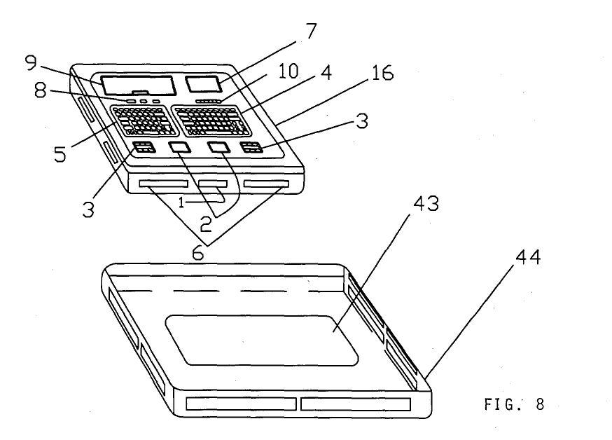

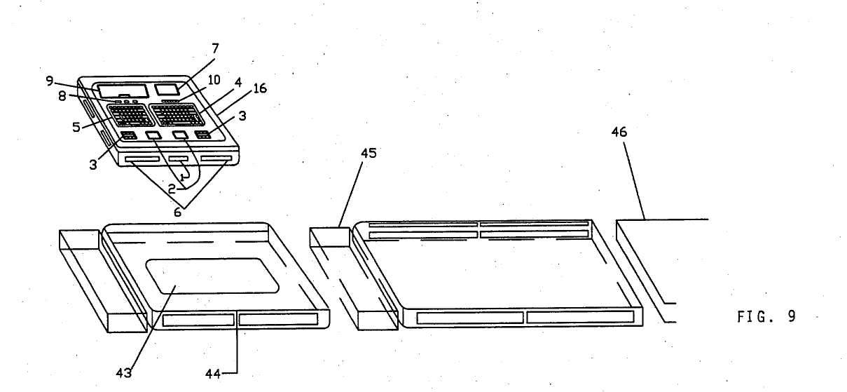

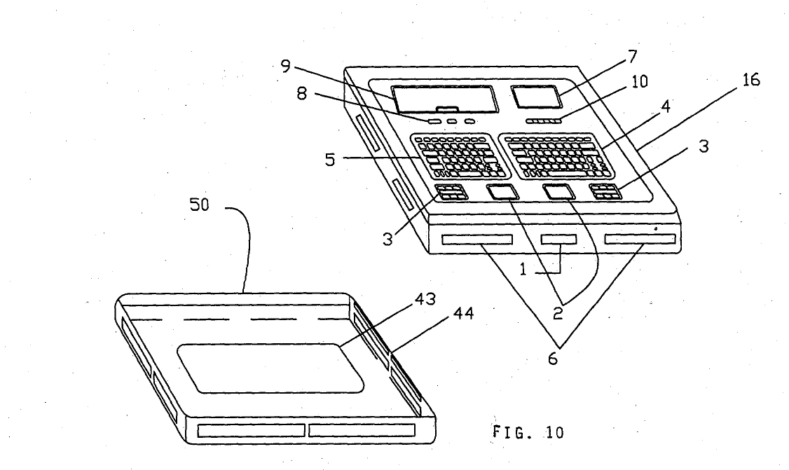

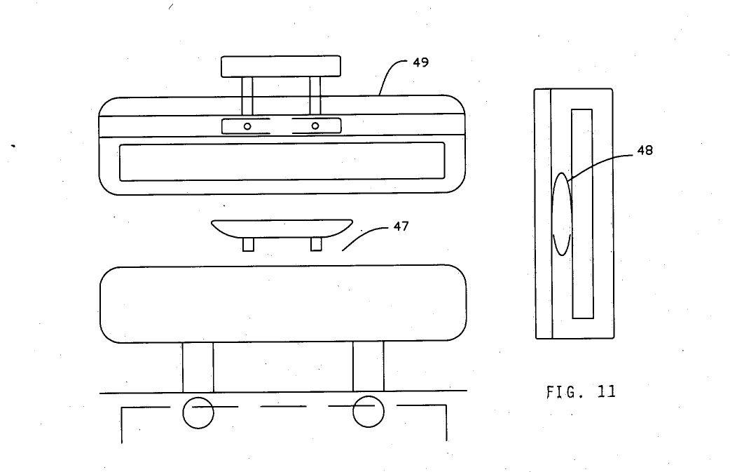

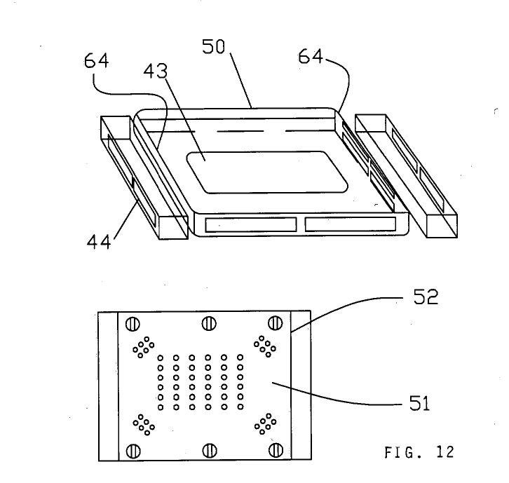

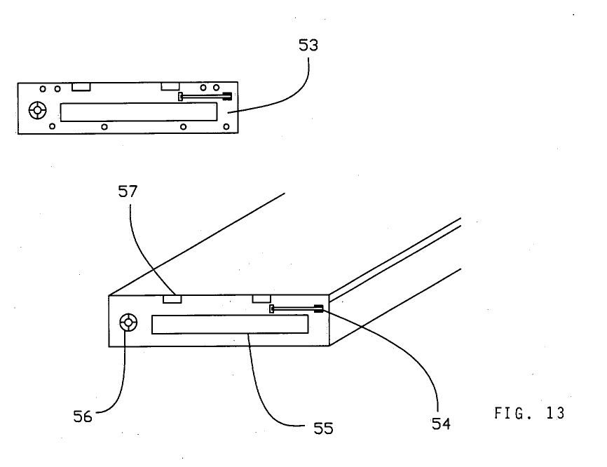

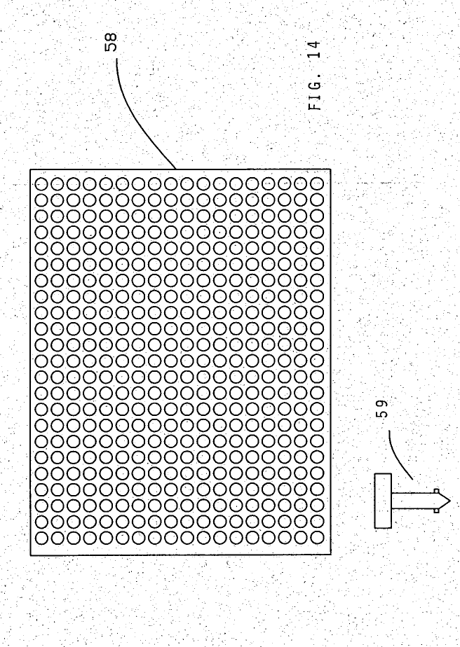

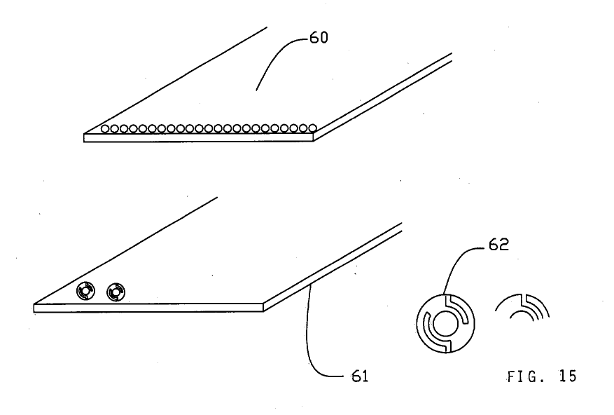

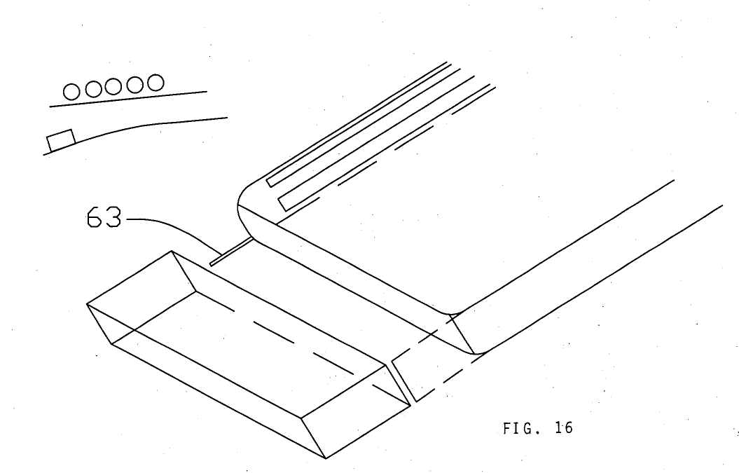

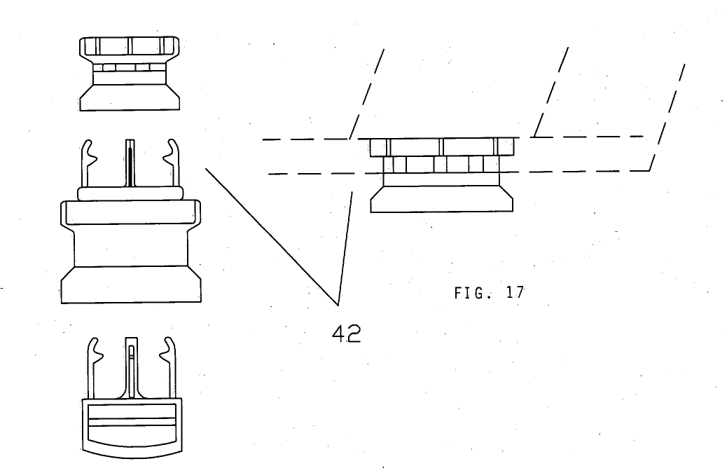

A preferred embodiment of the case of the present invention is illustrated in FIGS. 1 through 17. These sections of the case are two parts of a three-part system. The top part is the solar panel on one side and the display screen on the other. The outside housing (34) of the top part has solar panels (35) center of solar panel (rear view). There is a raised, bubbled edge (36) that protects the solar panel from damage. Also, embedded in the edge is a power light indicator (38). On the opposite side of the solar panel, there is a low profile edge that fits tightly, but protects the display screen when disconnected from the middle. FIG. 2 shows all three sections, the top, middle, and bottom. On FIG. 17, at the bottom of the top section are the hinges to the case (42). These pieces are held together with interlocking hinges (42). These hinges will allow each section of the case to open and close. Also, they will allow each unit to be disconnected independently for convenience and accessibility. These hinges will allow for the interchangeable position for the display screen so it may be utilized as a tablet. The next section is the flap (50) for accessibility to the plug-in cable connections when not in use and leave a streamline view of the case.

At the bottom of the display unit are retractable feet (41). The feet will have a spring on the center, circular piece to help pull them to the unit. The outer part of the feet will have an angular part that will fit on the bottom to hold the feet in place.

On the inner low profile edge are the controls to the display screen and light indicators (37), which set slightly lower than the protective edge. The display screen can operate as a whole or can be broken up into two single responding screens, which can operate independently (39 & 40).

There are two types of mountings for the display screen: one, the rubber mounting unit, and two, the metal mounting unit. On the outside of the back section of the solar panel is where the mounting frame is located. Next to the outer back section (18) is a rubber piece (19) held by a metal frame with metal screws to actually hold the display screen in place. And, on the display side is the face covering (21) to the display screen, which is perforated (22) to accomodate the display screen size. The other CDL Mounting Unit (31) contains a frame that moves horizontally on a tract (27) and is tightened by screws (23, 26, & 29) to hold the display screen in place. There are also vertical pieces (25) that are held in place by brackets (22 & 28). There is a face cover (33) with knockout sections (32) to house the display screen (30).

The middle section has a handle (1) that retracts into the case. FIGS. 47,48, & 49 are different views of the handle. There is a space to the left and right of the handle, which has knockout panels(6). The top is the area in which most of the input devices are mounted. The top can be lifted up to have access to the inside (16). Underneath the top, at the bottom of the case, one or more boards can be mounted (43). Also, there is an area where one or more daughterboards or one or more expansion slots (11, 12, 13, & 14) can be placed. The case, from the bottom, has two mice (2) to use in controlling the display unit. Also, there are two speakers (3) at the bottom, connected to the bottom lid.

The next section is the keyboard (4 & 5). The keyboard (4) on the right of the console will be stationary. The keyboard on the left (5) will be removable and will work by RF Frequency. The left keyboard will have a built on mouse or tracker ball. The next part on the console will be the LDC Display (7 & 9) with indicator lights (8 & 10). The inside of the middle section is where the motherboards for the units will be housed and the MCICIA Cards (44) will be placed. This unit will house circuit boards and some small batteries, and plug-in-place slots inside (11, 12, 13, & 14). There is a single profile indicating how the speakers and mice will set on the top panel (17). There is one other section that is ventilated, the middle (53) section. This section will have a small fan to pull heat from the electronic boards and small ventilation holes in front so air can circulate. In the back where this ventilation fan is located (56), there will be an opening entrance with a door that closes to hide the plug-in connections (55). One other part, which is the antenna (54) is connected on the back. FIG. 57 is a streamline section of the rear of the case where it fits together.

The bottom section is a box in which the panels can be knocked out. It has slots for plug and play units. This is where two periperals can be placed. And, it has two end pieces (45 & 46) to pull out for extra space to add more components. The next section on the bottom deals with ventilation (51). There are holes in the bottom of the case to keep the components cool (52). Also, there can be mounting for a fan to assist in cooling. There is a locking apparatus to set the distance on the end pieces (63). There is one other section that is ventilated, the bottom unit. This section will have a small fan to pull heat from the electronic boards and small ventilation holes in front so air can circulate. In the back where this ventilation fan is located (64), there will be an opening entrance with a door that closes to hide the plug-in connection.

In order to hold everything in place, screws can be placed from the bottom (48). These screws will hold mostly the mounting board (15), but can hold other components directly. The board that sets in the bottom has holes that have grooves. A notch screw fits into the holes and twists to lock them. These are shown in FIGS. 60, 61, & 62. FIGS. 58 & 59 will give you a better concept of the mounting board and screw.

### ADVANTAGES From the description above, a number of advantages of my Universal Laptop Case becomes evident:

(a) This will provide interchangeable plastic enclosure such as transparent and multi-colored ones.

(b) There will be no need to constantly buy new computer units every there to five years, just upgrade the internal motherboards, daughterboards, and software.

(c) The interchangeable plug and play cards will make the case into a special designated piece of equipment and not just a traditional computer.

(d) This will allow connection of several motherboards and daughterboards to operate on different aspects of a given task simultaneously.

(e) The computer case will truly allow itself to be multi-user from remote locations.

(f) This case will operate as a mini-main frame.

(g) This unit will act as a dedicated appliance by utilizing the daughterboards and net-working other components in the case.

(h) It will have a solar cell for power management features and power enhancement to offset power consumption.

(i) It will be able to expand for excessive component integration and configuration, depending on the configuration and can be separated into three main part: the display, the keyboard, the keyboard viewing section, and the bottom enclosure containing the peripherals.

(j) An internal, flexible, mounting system will allow many physical configurations for motherboard components and electronic controller circuits.

(k) This case will be lightweight, portable, and rugged.

### CONCLUSION, RAMIFICATIONS, AND SCOPE

Accordingly, the reader will see that this case can enable the user to create many different computer configurations, use several operating systems' test equipment, and dedicated controller cards for more than one user at the same time. This case will be a user-friendly case to create desired needed functions.

The case permits the use of several pieces of equipment with probes, lead wires, and desired functional attachments.

The case permits an interaction with several pieces of test equipment software.

The case permits the expansion of a wireless system of several computer and test equipment in the same case.

The case permits physical expansion to add many possible configurations of components.

The case permits power enhancement with solar cells.

Although the description above contains many specifics these should not be construed as limiting the scope of the invention, but merely providing illustrations of some of the presently preferred embodiments of this invention. For example, the case can have other shapes, such as circular, oval, trapezoidal, triangular, cubicle, etc.

Thus, the scope of the invention should be determined by the appended claims and legal equivalents, rather than by the example given.

What is claimed is:

1. A universal laptop case that provides an enclosure that accepts either laptop PC or desktop PC components.

2. A universal laptop case as claimed 1, wherein: said enclosure provides “knockout” panels to aid in installed component sizing to permit a perfect fit.

3. A universal laptop case as claimed 1, wherein: said enclosure provides “knockout” panels that offer flexibility in battery pack sizing and ampere-hour ratings.

4. A universal laptop case as claimed 1, wherein: said enclosure provides that ability to hybrid a laptop case, display screens and keyboard with existing desktop hardware, such as motherboards, disk drives, video and multimedia card, etc.

5. A universal laptop case as claimed 1, wherein: said enclosure provides a heat dissipation system, to dissipate heat from the motherboard and other installed components, which comprises: enclosure vents and mini-fans or alternatively a liquid cooling system with a miniature fluid pump routing through a plurality of capillaries milled into the fin of a heat sink.

6. A universal laptop case as claimed 5, wherein: said enclosure provides a heat dissipation system, to dissipate heat from power supply components, which comprises: a fin heat sink located on the outside of the enclosure.

7. A universal laptop case as claimed 1, wherein: said enclosure provides AC to DC power inverter to power peripheral devices.

8. A universal laptop case as claimed 1, wherein said enclosure provides accommodations for portable, multiple computers with multiple components, working single or networked together for operation with two or more displays:
(a) with computers comprising multiple display screens, input interface presentational devices, display screens, configured to operate as independent dedicated unit or networking together as a parallel architectural processing unit, controlled display by use of switching systems in the portable case.
(b) with computers comprising multiple user terminals to access one or all computers in the portable case.
(c) with detachable software to control motherboard as device or instrument.
(d) with multi-display systems, comprising of electronic presentation, interfaced with input devices to any one of a stylus, using finger and a light pen.
(e) with two keyboards with mice and a third mouse that is smart to provide multi-interfacing functions.

9. A universal laptop case as claimed 1, wherein said enclosure provides one case that splits into separate functional components

10. A universal laptop case as claimed 1, wherein said enclosure provides solar panel with additional add-on panels.

11. A universal laptop case as 1, wherein said enclosure provides detachable mounting holes that have grooves, boards with notches for screws to fit into holes so screws can be twisted to lock.
